(19) United States
(12) Patent Application Publication
(10) Pub. No.: US 2026/0347959 A1
(43) Pub. Date: Nov. 5, 2026

(54) Method and device for producing direct reduced iron by means of hydrogen-based shaft furnace

(71) Applicant: CISDI ENGINEERING CO., LTD., Chongqing (CN)

(72) Inventors: Kaiji Wu, Chongqing (CN); Tao Zhang, Chongqing (CN); Jun Zheng, Chongqing (CN); Xuekun He, Chongqing (CN); Weiqiang Qian, Chongqing (CN); Jiamei Li, Chongqing (CN); Xiaobo Zhai, Chongqing (CN); Chong Liu, Chongqing (CN); Lijun Jiang, Chongqing (CN)

(21) Appl. No.: 18/839,017

(22) PCT Filed: Jul. 8, 2022
(86) PCT No.: PCT/CN2022/104515

§ 371 Date: May 19, 2025

(30) Foreign Application Priority Data
Mar. 14, 2022 (CN) 202210248606.1

(51) Int. Cl. C21B 13/00; C21B 13/02

(52) U.S. Cl. CPC C21B 13/0073; C21B 13/02; C21B 2100/24; C21B 2100/282; C21B 2100/40

(57) ABSTRACT

The present invention relates to a method and a device for producing direct reduced iron by means of a hydrogen-based shaft furnace, belonging to the field of metallurgical industry technology. The method involves extracting top gas from the shaft furnace, decarbonizing it to separate CO2 and decarbonized gas, then pressurizing the CO2 gas and mixing it with H2 gas. The resulting mixture undergoes a water-gas shift reaction to produce a carbon-containing hydrogen-rich gas, which includes H2, CO, and H2O. The decarbonized gas is then combined with this hydrogen-rich gas, with additional carbon-hydrogen gas added to form reducing gas. This reducing gas is reintroduced into the shaft furnace to produce direct reduced iron, achieving internal carbon circulation and transformation through the water-gas shift reaction.

### TECHNICAL FIELD

This invention belongs to the field of metallurgical industry technology and relates to a method and device for producing direct reduced iron using a hydrogen-based shaft furnace.

### BACKGROUND TECHNOLOGY

The Direct Reduced Iron (DRI) process is a short process for steel production, which is a crucial link in the scrap/direct reduced iron-electric furnace process. Compared to the traditional blast furnace ironmaking process, the direct reduced ironmaking method, especially the gas-based direct reduction process, has a more significant carbon reduction effect.

As the most typical application of direct reduced ironmaking technology in the world, the gas-based shaft furnace process generally uses natural gas reforming methods to produce reduction gas mainly composed of H2 and CO, achieving direct reduced iron. The carbon oxides produced from the top gas of the shaft furnace, such as CO and CO2, are primarily handled by partially reusing CO2 and mixing it with methane, with a portion of the CO2being expelled through an external discharge system.

### SUMMARY OF THE INVENTION

In view of this, the purpose of the present invention is to provide a method and device for producing direct reduced iron using a hydrogen-based shaft furnace, aimed at addressing the high carbon emission problem in the production of direct reduced iron using gas-based shaft furnaces in the prior art.

To achieve the above purpose, the present invention provides the following technical solutions:

### Method for Producing Direct Reduced Iron Using a Hydrogen-Based Shaft Furnace

This method includes:
1. Obtaining the top gas output from the gas-based shaft furnace;
2. Performing decarbonization treatment on the top gas to output CO2 gas and decarbonized gas;
3. Pressurizing the CO2 gas and mixing it with input H2 gas;
4. Subjecting the mixed CO2 gas and H2 gas to a water-gas shift reaction to obtain carbon-containing hydrogen-rich gas, which includes H2, CO, and H2O;
5. Mixing the decarbonized gas with the carbon-containing hydrogen-rich gas, supplementing with carbon-hydrogen gas and mixing again to obtain shaft furnace reducing gas;
6. Introducing the shaft furnace reducing gas into the gas-based shaft furnace to produce direct reduced iron.

Optional steps include:
Prior to the decarbonization treatment, washing and dehydrating the top gas.
After obtaining the carbon-containing hydrogen-rich gas from the water-gas shift reaction, exchanging heat with the carbon-containing hydrogen-rich gas, inputting the recovered heat into the water-gas shift reaction, and dehydrating the carbon-containing hydrogen-rich gas.
The carbon-hydrogen gas includes at least one of the following: natural gas, liquefied petroleum gas.
In the step of pressurizing the CO2 gas and mixing it with input H2 gas, the molar ratio of input H2 gas to CO2 gas is between 1.5 and 5.
The temperature for the water-gas shift reaction of the mixed CO2 gas and H2 gas is between 200 °C and 900 °C.
In the carbon-containing hydrogen-rich gas, the volume percentage of H2 is between 40% and 55%, the volume percentage of CO is between 15% and 30%, the volume percentage of H2O is between 15% and 30%, and the volume percentage of CO2 is between 0% and 10%.

### Device for Producing Direct Reduced Iron Using a Hydrogen-Based Shaft Furnace

This device includes:
A gas-based shaft furnace for outputting top gas;
A decarbonization system for performing decarbonization treatment on the top gas to output CO2 gas and decarbonized gas;
A first mixing system for pressurizing the CO2 gas and mixing it with input H2 gas;
A water-gas shift reaction system for subjecting the mixed CO2 gas and H2 gas to a water-gas shift reaction to obtain carbon-containing hydrogen-rich gas, which includes H2, CO, and H2O;
A second mixing system for mixing the decarbonized gas with the carbon-containing hydrogen-rich gas, supplementing with carbon-hydrogen gas and mixing again to obtain shaft furnace reducing gas;
An output system for introducing the shaft furnace reducing gas into the gas-based shaft furnace to produce direct reduced iron.

Optional features include:
A gas purification and washing system at the output end of the gas-based shaft furnace for washing and dehydrating the top gas.
A heat exchange system at the output end of the water-gas shift reaction system for exchanging heat with the carbon-containing hydrogen-rich gas, with the recovered heat being input into the water-gas shift reaction.

### Beneficial Effects of the Invention

1. By mixing supplementary hydrogen with the carbon dioxide produced in the internal circulation process and using the water-gas shift reaction, the carbon in the shaft furnace process is transformed, achieving internal circulation utilization of carbon without emitting carbon oxides. Compared to traditional gas-based shaft furnace processes, this method is more environmentally friendly and low-carbon, with significant environmental benefits.
2. The process system only requires a small amount of carbon-hydrogen gas to maintain the carburizing demand for the shaft furnace DRI and balance the circulating reducing gas. The process layout is simple, and the energy consumption is relatively low.

Other advantages, objectives, and features of the invention will be explained to some extent in the following description, and to some extent, will be apparent to those skilled in the art from the study of the following or can be learned from the practice of the invention. The objectives and other advantages of the invention can be achieved and obtained through the following description.

### DESCRIPTION OF THE DRAWINGS

To make the objectives, technical solutions, and advantages of the present invention clearer, the following provides a preferred detailed description of the invention in conjunction with the accompanying drawings, wherein:

FIG. 1 is a schematic flow diagram of the method for producing direct reduced iron using a hydrogen-based shaft furnace according to the present invention;

FIG. 2 is a schematic structural diagram of the device for producing direct reduced iron using a hydrogen-based shaft furnace according to the present invention.

### DETAILED DESCRIPTION OF THE EMBODIMENTS

The following specific examples illustrate the embodiments of the present invention. Those skilled in the art can easily understand other advantages and effects of the present invention from the content disclosed in this specification. The present invention can also be implemented or applied through different specific embodiments, and various modifications or changes can be made to the details in this specification based on different viewpoints and applications without departing from the spirit of the present invention. It should be noted that the illustrations provided in the following embodiments are merely for illustrative purposes to explain the basic concept of the present invention. In cases of non-conflict, the following embodiments and the features therein can be combined with each other.

The drawings are for exemplary purposes only, representing schematic diagrams rather than actual physical diagrams, and should not be understood as limiting the present invention. For better explanation of the embodiments of the present invention, some parts in the drawings are omitted, enlarged, or reduced and do not represent the actual product sizes. For those skilled in the art, it is understandable that some known structures and their descriptions in the drawings may be omitted.

In the drawings of the embodiments of the present invention, the same or similar reference numerals correspond to the same or similar components. In the description of the present invention, it should be understood that the orientation or positional relationships indicated by terms such as “upper,” “lower,” “left,” “right,” “front,” and “rear” are based on the orientation or positional relationships shown in the drawings, and are only for the convenience of describing the present invention and simplifying the description. They do not indicate or imply that the referred devices or elements must have a specific orientation, be constructed in a specific orientation, or operate in a specific orientation. Therefore, the terms describing positional relationships in the drawings are only for illustrative purposes and should not be understood as limiting the present invention. For those skilled in the art, the specific meanings of the above terms can be understood according to specific circumstances.

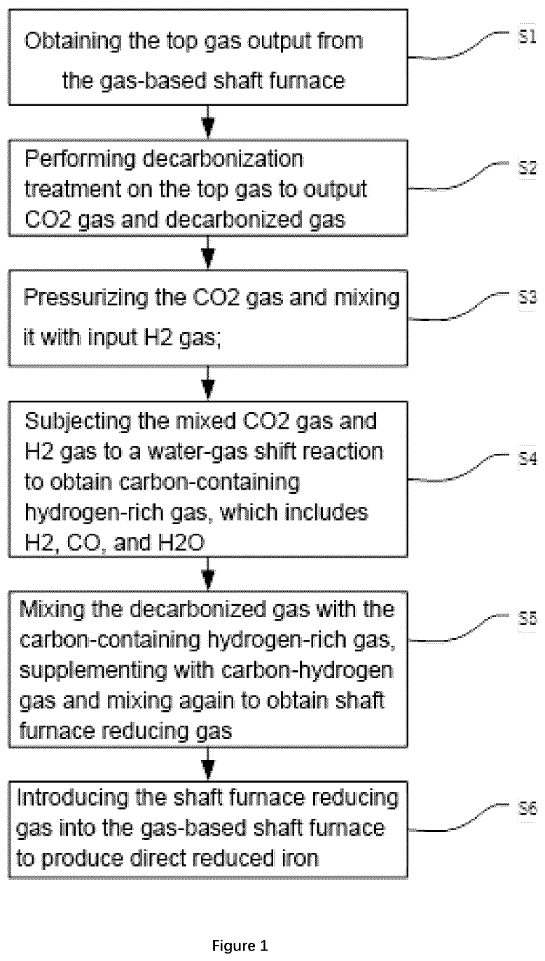

Refer to FIG. 1, which illustrates a method for producing direct reduced iron using a hydrogen-based shaft furnace, including:
S1: Obtaining the top gas output from the gas-based shaft furnace;
S2: Performing decarbonization treatment on the top gas to output CO2 gas and decarbonized gas;
S3: Pressurizing the CO2 gas and mixing it with input H2 gas;
S4: Subjecting the mixed CO2 gas and H2 gas to a water-gas shift reaction to obtain carbon-containing hydrogen-rich gas, which includes H2, CO, and H2O;
S5: Mixing the decarbonized gas with the carbon-containing hydrogen-rich gas, supplementing with carbon-hydrogen gas and mixing again to obtain shaft furnace reducing gas;
S6: Introducing the Shaft Furnace Reducing Gas Into the Gas-based Shaft Furnace to produce direct reduced iron.

By mixing supplementary hydrogen with the carbon dioxide produced in the internal circulation process and achieving carbon transformation in the shaft furnace process through the water-gas shift reaction, internal circulation utilization of carbon is realized without emitting carbon oxides. Compared to traditional gas-based shaft furnace processes, this method is greener and lower in carbon, with significant environmental benefits. The process system only requires a small amount of carbon-hydrogen gas to maintain the carburizing demand for the shaft furnace DRI and balance the circulating reducing gas, making the process layout simple and the energy consumption relatively low.

In some implementations, prior to decarbonization treatment, the top gas undergoes washing and dehydration.

Optionally, after obtaining the carbon-containing hydrogen-rich gas from the water-gas shift reaction, the process includes:
Exchanging heat with the carbon-containing hydrogen-rich gas, inputting the recovered heat into the water-gas shift reaction;
Dehydrating the carbon-containing hydrogen-rich gas.

Optionally, the carbon-hydrogen gas includes at least one of the following: natural gas, liquefied petroleum gas.

Optionally, in the step of pressurizing the CO2 gas and mixing it with input H2 gas, the molar ratio of input H2 gas to CO2 gas is between 1.5 and 5.0. For example, the pressure of supplementary H2 is ≥1.0 MPa (gauge pressure); the pressure of CO2 gas after pressurization is ≥1.0 MPa (gauge pressure). Further, the mixed gas undergoes the water-gas shift reaction system, generating carbon-containing hydrogen-rich gas mainly composed of H2, CO, and H2O.

The main chemical reaction of the water-gas shift reaction system is H2(g)+CO2(g)→CO(g)+H2O(g); the temperature requirement for the water-gas shift reaction system is 200 °C~900 °C; the total conversion rate of CO2 in the water-gas shift reaction system is >50%.

Optionally, the temperature for the water-gas shift reaction of the mixed CO2 gas and H2 gas is 200 °C~900 °C.

Optionally, in the carbon-containing hydrogen-rich gas, the volume percentage of H2 is 40%~55%, CO is 15%~30%, H2O is 15%~30%, and CO2 is 0%~10%. Further, after the heat exchange system, the carbon-containing hydrogen-rich gas has an H2 content of 55%~70% (volume Percentage), CO content of 20%, a temperature 40 °C, and H2O is separated and reused in the form of free water. The carbon-containing hydrogen-rich gas, after the heat exchange system, is mixed with the decarbonized gas output from the gas decarbonization system. This mixture, along with the supplementary H2 and natural gas that have been pressure-regulated and pretreated at the interface end of the shaft furnace system, forms the shaft furnace reducing gas.

The purity of the supplementary H2 is >99.9%; the supplementary natural gas is impurity-removed natural gas or liquefied petroleum gas (LPG).

Further, the shaft furnace reducing gas is heated in a tubular heating furnace to a certain temperature before entering the shaft furnace to produce DRI. The temperature of the reducing gas after heating is 850 °C, and the pressure of the reducing gas entering the shaft furnace is 1.0 MPa (gauge pressure).

Further, the top gas discharged from the top of the shaft furnace, after purification and washing and the gas decarbonization system, outputs by-product CO2 gas with a CO2 content of >90% (volume percentage), a pressure range of 0.05 MPa (gauge pressure), and a temperature of 40 °C.

Further, the gas decarbonization system is a dry or wet decarbonization device.

Further, the decarbonized gas output from the gas decarbonization system has an H2 content of 70%~90% (volume percentage), CO content of 8%~25% (volume percentage), H2O content of 0% (volume percentage), and a temperature of 40 °C.

In some implementations, the process route is: The top gas discharged from the top of the shaft furnace, after purification and washing and the gas decarbonization system, outputs by-product CO2 gas, which is pressurized and mixed with supplementary H2. The mixed gas undergoes the water-gas shift reaction system, generating carbon-containing hydrogen-rich gas mainly composed of H2, CO, and H2O. This carbon-containing hydrogen-rich gas, after the heat exchange system, is mixed with the decarbonized gas output from the gas decarbonization system. This mixture, along with the supplementary H2 and natural gas that have been pressure-regulated and pretreated at the interface end of the shaft furnace system, forms the shaft furnace reducing gas. The shaft furnace reducing gas is heated in a tubular heating furnace to a certain temperature before entering the shaft furnace to produce DRI.

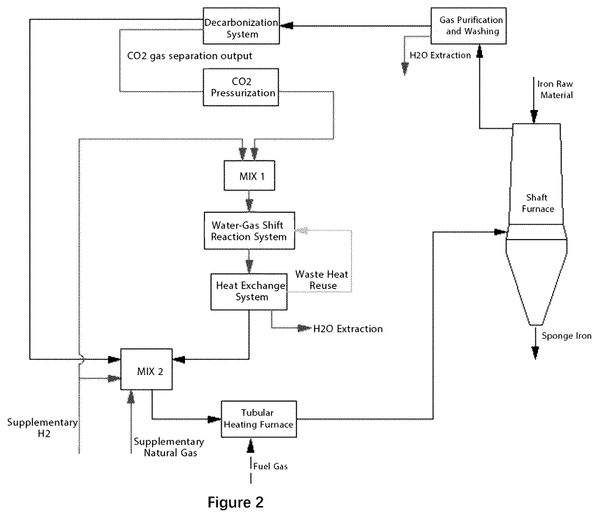

Refer to FIG. 2, which illustrates a device for producing direct reduced iron using a hydrogen-based shaft furnace, including:
A gas-based shaft furnace for outputting top gas;
A decarbonization system for performing decarbonization treatment on the top gas to output CO2 gas and decarbonized gas;
A first mixing system for pressurizing the CO2 gas and mixing it with input H2 gas;
A water-gas shift reaction system for subjecting the mixed CO2 gas and H2 gas to a water-gas shift reaction to obtain carbon-containing hydrogen-rich gas, which includes H2, CO, and H2O;
A second mixing system for mixing the decarbonized gas with the carbon-containing hydrogen-rich gas, supplementing with H2 and carbon-hydrogen gas and mixing again to obtain shaft furnace reducing gas;
An output system for heating the shaft furnace reducing gas in a tubular heating furnace before introducing it into the gas-based shaft furnace to produce direct reduced iron.

Optionally, a gas purification and washing system is provided at the output end of the gas-based shaft furnace for washing and dehydrating the top gas.

Optionally, a heat exchange system is provided at the output end of the water-gas shift reaction system for exchanging heat with the carbon-containing hydrogen-rich gas, with the recovered heat being input into the water-gas shift reaction.

The following further explains the technical solutions of the present invention through specific embodiments:

### Embodiment 1

The top gas discharged from the top of the shaft furnace, after purification, washing, and the gas decarbonization system, produces by-product CO2 gas. After pressurization and mixing with supplementary H2, the mixed gas undergoes a water-gas shift reaction system, generating carbon-containing hydrogen-rich gas mainly composed of H2, CO, and H2O.

After passing through the heat exchange system, the carbon-containing hydrogen-rich gas is mixed with the decarbonized gas from the gas decarbonization system and further mixed with supplementary H2 and NG that have been pressure-regulated and pretreated at the interface end of the shaft furnace system, forming the shaft furnace reducing gas. This reducing gas is then heated in a tubular heating furnace to a certain temperature before entering the shaft furnace to produce DRI.

After pressurization, the by-product CO2 gas from the gas decarbonization system is mixed with supplementary H2. The pressure of the CO2 gas after pressurization is 1.0 MPa (gauge pressure), and the molar ratio of supplementary H2 to CO2 is 3.0. The pressure of the supplementary H2 is 1.0 MPa (gauge pressure).

The mixed gas undergoes a water-gas shift reaction system, generating carbon-containing hydrogen-rich gas mainly composed of H2, CO, and H2O. The operating temperature within the water-gas shift reaction system is 480 °C, with a CO2 conversion rate of 90.5%. The resulting carbon-containing hydrogen-rich gas has the following composition: H2: 52.6% (volume percentage), CO: 22.5% (volume percentage), H2O(g): 22.54%, and residual CO2 content of 2.0%.

After passing through the heat exchange system, the carbon-containing hydrogen-rich gas has a temperature of 33 °C, an H2 content of 67.50% (volume percentage), a CO content of 28.90% (volume percentage), and a residual CO2 content of 3.0%.

The supplementary H2 input at the interface end of the shaft furnace system has a purity of 99.9% and a pressure of 1.0 MPa (gauge pressure), with the supplementary NG being liquefied petroleum gas. The shaft furnace reducing gas is heated in a tubular heating furnace, reaching a temperature of 900 °C and a pressure of 0.3 MPa (gauge pressure) before entering the shaft furnace.

After purification, washing, and the gas decarbonization system, the top gas discharged from the top of the shaft furnace produces by-product CO2 gas with a content of 99.8% (volume percentage), a temperature of 33 °C, and a gauge pressure of ~0.05 MPa. The gas decarbonization system is a wet decarbonization device.

The decarbonized gas output from the gas decarbonization system has a temperature of 33 °C, an H2 content of 87.6% (volume percentage), a CO content of 9.7% (volume percentage), a CO2 content of 0.2% (volume percentage), and an H2O content of ~1% (volume percentage).

### Embodiment 2

The top gas discharged from the top of the shaft furnace, after purification, washing, and the gas decarbonization system, produces by-product CO2 gas. After pressurization and mixing with supplementary H2, the mixed gas undergoes a water-gas shift reaction system, generating carbon-containing hydrogen-rich gas mainly composed of H2, CO, and H2O. After passing through the heat exchange system, the carbon-containing hydrogen-rich gas is mixed with the decarbonized gas from the gas decarbonization system and further mixed with supplementary H2 and NG that have been pressure-regulated and pretreated at the interface end of the shaft furnace system, forming the shaft furnace reducing gas. This reducing gas is then heated in a tubular heating furnace to a certain temperature before entering the shaft furnace to produce DRI.

After pressurization, the by-product CO2 gas from the gas decarbonization system is mixed with supplementary H2. The pressure of the CO2 gas after pressurization is 1.0 MPa (gauge pressure), and the molar ratio of supplementary H2 to CO2 is 3.0. The pressure of the supplementary H2 is 1.0 MPa (gauge pressure).

The mixed gas undergoes a water-gas shift reaction system, generating carbon-containing hydrogen-rich gas mainly composed of H2, CO, and H2O. The operating temperature within the water-gas shift reaction system is 520 °C, with a CO2 conversion rate of 91.5%. The resulting carbon-containing hydrogen-rich gas has the following composition: H2: 54.50% (volume percentage), CO: 17.50% (volume percentage), H2O(g): 17.50%, and residual CO2 content of 7.50%.

After passing through the heat exchange system, the carbon-containing hydrogen-rich gas has a temperature of 38 °C, an H2 content of 69.4% (volume percentage), a CO content of 21.1% (volume percentage), and a residual CO2 content of 9.0%.

The supplementary H2 input at the interface end of the shaft furnace system has a purity of 99.9% and a pressure of 1.0 MPa (gauge pressure), with the supplementary NG being impurity-removed natural gas. The shaft furnace reducing gas is heated in a tubular heating furnace, reaching a temperature of 900 °C and a pressure of 0.3 MPa (gauge pressure) before entering the shaft furnace.

After purification, washing, and the gas decarbonization system, the top gas discharged from the top of the shaft furnace produces by-product CO2 gas with a content of 99.7% (volume percentage), a temperature of 36 °C, and a gauge pressure of ~0.05 MPa. The gas decarbonization system is a wet decarbonization device.

The decarbonized gas output from the gas decarbonization system has a temperature of 36 °C, an H2 content of 86.61% (volume percentage), a CO content of 12.41% (volume percentage), a CO2 content of 0.3% (volume percentage), and an H2O content of 0.7% (volume percentage).

### Embodiment 3

The top gas discharged from the top of the shaft furnace, after purification, washing, and the gas decarbonization system, produces by-product CO2 gas. After pressurization and mixing with supplementary H2, the mixed gas undergoes a water-gas shift reaction system, generating carbon-containing hydrogen-rich gas mainly composed of H2, CO, and H2O. After passing through the heat exchange system, the carbon-containing hydrogen-rich gas is mixed with the decarbonized gas from the gas decarbonization system and further mixed with supplementary H2 and NG that have been pressure-regulated and pretreated at the interface end of the shaft furnace system, forming the shaft furnace reducing gas. This reducing gas is then heated in a tubular heating furnace to a certain temperature before entering the shaft furnace to produce DRI.

After pressurization, the by-product CO2 gas from the gas decarbonization system is mixed with supplementary H2. The pressure of the CO2 gas after pressurization is 1.0 MPa (gauge pressure), and the molar ratio of supplementary H2 to CO2 is 3.0. The pressure of the supplementary H2 is 1.0 MPa (gauge pressure).

The mixed gas undergoes a water-gas shift reaction system, generating carbon-containing hydrogen-rich gas mainly composed of H2, CO, and H2O. The operating temperature within the water-gas shift reaction system is 520 °C, with a CO2 conversion rate of 92%. The resulting carbon-containing hydrogen-rich gas has the following composition: H2: 57.57% (volume Percentage), Co: 17.47% (volume Percentage), H2O (g): 17.47%, and residual CO2 content of 7.4%.

After passing through the heat exchange system, the carbon-containing hydrogen-rich gas has a temperature of 34 °C, an H2 content of 69.51% (volume percentage), a CO content of 21.09% (volume percentage), and a residual CO2 content of 8.9%.

The supplementary H2 input at the interface end of the shaft furnace system has a purity of 99.9% and a pressure of 1.0 MPa (gauge pressure), with the supplementary NG being impurity-removed natural gas. The shaft furnace reducing gas is heated in a tubular heating furnace, reaching a temperature of 900 °C and a pressure of 0.3 MPa (gauge pressure) before entering the shaft furnace.

After purification, washing, and the gas decarbonization system, the top gas discharged from the top of the shaft furnace produces by-product CO2 gas with a content of 99.6% (volume percentage), a temperature of 35 °C, and a gauge pressure of ~0.05 MPa. The gas decarbonization system is a wet decarbonization device.

The decarbonized gas output from the gas decarbonization system has a temperature of 35 °C, an H2 content of 82.5% (volume percentage), a CO content of 16.4% (volume percentage), a CO2 content of 0.4% (volume percentage), and an H2O content of 0.7% (volume percentage).

### Embodiment 4

The top gas discharged from the top of the shaft furnace, after purification, washing, and the gas decarbonization system, produces by-product CO2 gas. After pressurization and mixing with supplementary H2, the mixed gas undergoes a water-gas shift reaction system, generating carbon-containing hydrogen-rich gas mainly composed of H2, CO, and H2O. After passing through the heat exchange system, the carbon-containing hydrogen-rich gas is mixed with the decarbonized gas from the gas decarbonization system and further mixed with supplementary H2 and NG that have been pressure-regulated and pretreated at the interface end of the shaft furnace system, forming the shaft furnace reducing gas. This reducing gas is then heated in a tubular heating furnace to a certain temperature before entering the shaft furnace to produce DRI.

After pressurization, the by-product CO2 gas from the gas decarbonization system is mixed with supplementary H2. The pressure of the CO2 gas after pressurization is 1.0 MPa (gauge pressure), and the molar ratio of supplementary H2 to CO2 is 2.0. The pressure of the supplementary H2 is 1.0 MPa (gauge pressure).

The mixed gas undergoes a water-gas shift reaction system, generating carbon-containing hydrogen-rich gas mainly composed of H2, CO, and H2O. The operating temperature within the water-gas shift reaction system is 500 °C, with a CO2 conversion rate of 90%. The resulting carbon-containing hydrogen-rich gas has the following composition: H2: 43.33% (volume percentage), CO: 23.3% (volume percentage), H2O(g): 23.3%, and residual CO2 content of 10.0%.

After passing through the heat exchange system, the carbon-containing hydrogen-rich gas has a temperature of 35 °C, an H2 content of 56.31% (volume percentage), a CO content of 30.32% (volume percentage), and a residual CO2 content of 12.9%.

The supplementary H2 input at the interface end of the shaft furnace system has a purity of 99.9% and a pressure of 1.0 MPa (gauge pressure), with the supplementary NG being liquefied petroleum gas. The shaft furnace reducing gas is heated in a tubular heating furnace, reaching a temperature of 900 °C and a pressure of 0.3 MPa (gauge pressure) before entering the shaft furnace.

After purification, washing, and the gas decarbonization system, the top gas discharged from the top of the shaft furnace produces by-product CO2 gas with a content of 99.4% (volume percentage), a temperature of 35 °C, and a gauge pressure of ~0.06 MPa. The gas decarbonization system is a wet decarbonization device.

The decarbonized gas output from the gas decarbonization system has a temperature of 35 °C, an H2 content of 74.12% (volume percentage), a CO content of 24.57% (volume percentage), a CO2 content of 0.6% (volume percentage), and an H2O content of 0.7% (volume percentage).

### Embodiment 5

The top gas discharged from the top of the shaft furnace, after purification, washing, and the gas decarbonization system, produces by-product CO2 gas. After pressurization and mixing with supplementary H2, the mixed gas undergoes a water-gas shift reaction system, generating carbon-containing hydrogen-rich gas mainly composed of H2, CO, and H2O. After passing through the heat exchange system, the carbon-containing hydrogen-rich gas is mixed with the decarbonized gas from the gas decarbonization system and further mixed with supplementary H2 and NG that have been pressure-regulated and pretreated at the interface end of the shaft furnace system, forming the shaft furnace reducing gas. This reducing gas is then heated in a tubular heating furnace to a certain temperature before entering the shaft furnace to produce DRI.

After pressurization, the by-product CO2 gas from the gas decarbonization system is mixed with supplementary H2. The pressure of the CO2 gas after pressurization is 1.0 MPa (gauge pressure), and the molar ratio of supplementary H2 to CO2 is 1.6. The pressure of the supplementary H2 is 1.0 MPa (gauge pressure).

The mixed gas undergoes a water-gas shift reaction system, generating carbon-containing hydrogen-rich gas mainly composed of H2, CO, and H2O. The operating temperature within the water-gas shift reaction system is 500 °C, with a CO2 conversion rate of 88%. The resulting carbon-containing hydrogen-rich gas has the following composition: H2: 33.63% (volume percentage), CO: 27.3% (volume percentage), H2O(g): 27.3%, and residual CO2 content of 11.7%.

After passing through the heat exchange system, the carbon-containing hydrogen-rich gas has a temperature of 35 °C, an H2 content of 46.10% (volume percentage), a CO content of 37.47% (volume percentage), and a residual CO2 content of 16.06%.

The supplementary H2 input at the interface end of the shaft furnace system has a purity of 99.9% and a pressure of 1.0 MPa (gauge pressure), with the supplementary NG being liquefied petroleum gas. The shaft furnace reducing gas is heated in a tubular heating furnace, reaching a temperature of 900 °C and a pressure of 0.3 MPa (gauge pressure) before entering the shaft furnace.

After purification, washing, and the gas decarbonization system, the top gas discharged from the top of the shaft furnace produces by-product CO2 gas with a content of 99.4% (volume percentage), a temperature of 35 °C, and a gauge pressure of ~0.06 MPa. The gas decarbonization system is a wet decarbonization device.

The decarbonized gas output from the gas decarbonization system has a temperature of 35 °C, an H2 content of 74.12% (volume percentage), a CO content of 24.57% (volume percentage), a CO2 content of 0.6% (volume percentage), and an H2O content of 0.7% (volume percentage).

### Final Notes

It should be noted that the above embodiments are only to illustrate the technical solutions of the present invention, and not to limit them. Although the present invention has been described in detail with reference to the preferred embodiments, those skilled in the art should understand that modifications or equivalent replacements can be made to the technical solutions of the present invention without departing from the spirit and scope of the technical solutions, and they should be encompassed within the scope of the claims of the present invention.

1. A method for producing direct reduced iron using a hydrogen-based shaft furnace, characterized by comprising:
Obtaining the top gas output from the gas-based shaft furnace;
Performing decarbonization treatment on the top gas to output CO2 gas and decarbonized gas;
Pressurizing the CO2 gas and mixing it with the input H2 gas;
Subjecting the mixed CO2 gas and H2 gas to a water-gas shift reaction to obtain carbon-containing hydrogen-rich gas, which includes H2, CO, and H2O;
Mixing the decarbonized gas with the carbon-containing hydrogen-rich gas, supplementing with carbon-hydrogen gas and mixing again to obtain shaft furnace reducing gas;
Introducing the shaft furnace reducing gas into the gas-based shaft furnace to produce direct reduced iron.

2. The method for producing direct reduced iron using a hydrogen-based shaft furnace according to claim 1, characterized in that the decarbonization treatment of the top gas includes washing and dehydrating the top gas.

3. The method for producing direct reduced iron using a hydrogen-based shaft furnace according to claim 1, characterized in that after the step of subjecting the mixed CO2 gas and H2 gas to a water-gas shift reaction to obtain carbon-containing hydrogen-rich gas, it further includes:
Exchanging heat with the carbon-containing hydrogen-rich gas, and inputting the recovered heat into the water-gas shift reaction;
Dehydrating the carbon-containing hydrogen-rich gas.

4. The method for producing direct reduced iron using a hydrogen-based shaft furnace according to claim 1, characterized in that the carbon-hydrogen gas includes at least one of the following: natural gas, liquefied petroleum gas.

5. The method for producing direct reduced iron using a hydrogen-based shaft furnace according to claim 1, characterized in that in the step of pressurizing the CO2 gas and mixing it with the input H2 gas, the molar ratio of the input H2 gas to the CO2 gas is between 1.5 and 5.0.

6. The method for producing direct reduced iron using a hydrogen-based shaft furnace according to claim 1, characterized in that the temperature for the water-gas shift reaction of the mixed CO2 gas and H2 gas is between 200 °C and 900 °C.

7. The method for producing direct reduced iron using a hydrogen-based shaft furnace according to claim 1, characterized in that in the carbon-containing hydrogen-rich gas, the volume percentage of H2 is between 40% and 55%, the volume percentage of CO is between 15% and 30%, the volume percentage of H2O is between 15% and 30%, and the volume percentage of CO2 is between 0% and 10%.

8. A device for producing direct reduced iron using a hydrogen-based shaft furnace, characterized by comprising:
A gas-based shaft furnace for outputting top gas;
A decarbonization system for performing decarbonization treatment on the top gas to output CO2 gas and decarbonized gas;
A first mixing system for pressurizing the CO2 gas and mixing it with the input H2 gas;
A water-gas shift reaction system for subjecting the mixed CO2 gas and H2 gas to a water-gas shift reaction to obtain carbon-containing hydrogen-rich gas, which includes H2, CO, and H2O;
A second mixing system for mixing the decarbonized gas with the carbon-containing hydrogen-rich gas, supplementing with carbon-hydrogen gas and mixing again to obtain shaft furnace reducing gas;
An output system for introducing the shaft furnace reducing gas into the gas-based shaft furnace to produce direct reduced iron.

9. The device for producing direct reduced iron using a hydrogen-based shaft furnace according to claim 8, characterized in that the output end of the gas-based shaft furnace is also provided with a gas purification and washing system, which is used for washing and dehydrating the top gas.

10. The device for producing direct reduced iron using a hydrogen-based shaft furnace according to claim 8, characterized in that the output end of the water-gas shift reaction system is provided with a heat exchange system, which is used for exchanging heat with the carbon-containing hydrogen-rich gas, and inputting the recovered heat into the water-gas shift reaction.
